(19) United States
(12) Patent Application Publication
(10) Pub. No.: US 2024/0236534 A1
(43) Pub. Date: Jul. 11, 2024

(54) Speaker Device

(71) Applicant: FOSTER ELECTRIC COMPANY, LIMITED, Tokyo (JP)

(72) Inventors: Takayuki Tabata, Akishima-shi, Tokyo (JP); Jun Yoshida, Akishima-shi, Tokyo (JP)

(21) Appl. No.: 18/557,587

(22) PCT Filed: Apr. 21, 2022
(86) PCT No.: PCT/JP2022/018489

§ 371 Date: Oct. 26, 2023

(30) Foreign Application Priority Data
Apr. 30, 2021 (JP) 2021-077573

(51) Int. Cl. H04R 1/02; B60R 11/00; B60R 11/02; H04R 1/28

(52) U.S. Cl. CPC H04R 1/025; H04R 1/2811; B60R 2011/0003; B60R 11/0217; H04R 2400/11; H04R 2499/13

(57) ABSTRACT

A speaker device is provided in the cabin interior of a vehicle at which a closed cross-section portion is formed by a cowl side panel and a front fender panel. The speaker device includes a speaker frame that is fixed to the cowl side panel and that partitions a space at a rear face side of a diaphragm relative to a space at a front face side of the diaphragm, and a port extending from a side face of the speaker frame, the port mutually communicating a first space at the rear face side of the diaphragm with an interior of the closed cross-section portion.

### TECHNICAL FIELD

The present disclosure relates to a speaker device.

### BACKGROUND ART

Japanese National Phase Publication (JP-A) No. 2013-509049 discloses a speaker device attached to an outer panel of a vehicle. In this speaker device, a duct (port) is connected between a chamber provided at the rear face side of a diaphragm and the outer panel of the vehicle.

### SUMMARY OF THE INVENTION

### Problem to be Solved by the Invention

However, with the technique described in JP-A No. 2013-509049, there are concerns that foreign matter such as snow, rainwater, dust, and insects from outside the vehicle may enter into the port of the speaker device and the speaker frame through the opening of the port, and the playback performance of the speaker device may deteriorate.

In consideration of the foregoing circumstances, the present disclosure aims to provide a speaker device that is installed at a vehicle and is able to preventing foreign matter from entering into a port and a speaker frame.

### Means for Solving the Problem

A speaker device according to a first aspect of the present disclosure is a speaker device provided at a vehicle cabin interior at which a closed cross-section portion is formed by an inner panel and an outer panel, the speaker device comprising: a speaker frame that is fixed to the inner panel and that partitions a space at a rear face side of a diaphragm relative to a space at a front face side of the diaphragm; and a port extending from a side face of the speaker frame, in which the port communicates the space at the rear face side of the diaphragm and an interior of the closed cross-section portion with each other.

According to the first aspect, the space at the rear face side of the diaphragm and the interior of the closed cross-section portion formed by the inner panel and the outer panel are communicated with each other via a port extending from the side surface of the speaker frame. Accordingly, since an opening at a leading end side of the port is disposed oriented toward the interior of the closed cross-section portion, foreign matter such as snow, rainwater, dust, and insects from outside the vehicle can be prevented from entering into the port of the speaker device or the speaker frame via the opening of the port. Accordingly, the flow of air within the port and the speaker frame is not obstructed by foreign matter, and favorable reproduction performance of the speaker device can be maintained.

Moreover, air can enter and exit between the space at the rear face side of the diaphragm and the interior of the closed cross-section portion formed by the inner panel and the outer panel, via the port. Accordingly, compared to a case of forming the space inside the speaker frame as a sealed space, interference by the air pressure within the speaker frame with the amplitude of the diaphragm is suppressed. Since, in this way, it is possible to release pressure from inside the speaker frame to the closed cross-section portion between the inner panel and the outer panel via the port, it is possible to achieve downsizing of the device while maintaining the amplitude of the diaphragm and maintaining the reproduction performance of the speaker device.

In the speaker device according to a second aspect of the present disclosure, in the configuration described in the first aspect, an opening area of the port is configured smaller than an area of the side face of the speaker frame to which the port is connected.

According to the second aspect, by configuring the opening area of the port to be smaller than the area of the side surface of the speaker frame to which the port is connected, the space at the rear face side of the diaphragm is formed as a closed space, and the air in the closed space resonates with the air in the port with which it is communicated, as an air spring.

The resonance point (resonance frequency) of the port is changed depending on the length of the port. Accordingly, by adjusting the length of the port, the resonance point of the port is changed, and by adjusting the resonance point of the air inside the port and the speaker frame, it becomes possible to intentionally adjust the sound pressure of sound reproduced by the speaker device in a predetermined frequency band.

In the present disclosure, since it is possible to dispose the leading end side of the port within the closed cross-section portion, in terms of securing installation space, fewer restrictions are caused by the structure of the vehicle, and the length of the port can be easily adjusted. As a result, sound reproduced by the speaker device can be adjusted with a simple structure.

Furthermore, since the leading end of the port is disposed within the closed cross-section portion, by adjusting the length and opening area of the port in accordance with variations in the sealing performance within the closed cross-section portion, it is possible to intentionally adjust the sound pressure of sound reproduced by the speaker device in a predetermined frequency band.

In the speaker device according to a third aspect of the present disclosure, in the configuration according to the first aspect or the second aspect, a leading end of the port is disposed at a vehicle inner side relative to a reinforcing member or a waterproof panel disposed between the inner panel and the outer panel in the closed cross-section portion. According to the third aspect, the leading end of the port is disposed at a vehicle inner side relative to a reinforcing member or a waterproof panel disposed between the inner panel and the outer panel. Accordingly, since the port can be attached at a position that does not interfere with the reinforcement and waterproof structure within the closed cross-section portion, the speaker device can be easily attached to the frame of the vehicle.

In the speaker device according to a fourth aspect of the present disclosure, in the configuration according to any one of the first to third aspects, a through hole, through which is inserted a harness connected to electrical equipment installed in the vehicle, is formed at the inner panel.

According to the fourth aspect, a through hole, through which a harness connected to electrical equipment is inserted, is formed at the inner panel. In this way, locations at which electrical components of a vehicle are installed are generally designed to be waterproof in readiness for a case in which the vehicle is submerged in water. Accordingly, even if an opening for a port is formed in the inner panel, waterproof performance within the closed cross-section portion can be ensured. Since, as a result, the need for waterproof design at the speaker device side is eliminated, the degree of freedom of design of the speaker device can be increased.

In the speaker device according to a fifth aspect of the present disclosure, in the configuration according to any one of the first to fourth aspects, an attachment leg portion that is attached to the inner panel is integrally formed at the port, and the attachment leg portion extends from an end portion of the port at a side of connection with the speaker frame and sets down on a side face at a vehicle cabin interior side of the inner panel.

According to the fifth aspect, the attachment leg portion provided integrally with the port extends from the end portion of the port at a side of connection with the speaker frame to the side face at a vehicle cabin interior side of the inner panel. Accordingly, the attachment leg portion of the port extends from near the center of gravity of the speaker device; that is, from near the speaker frame disposed at the vehicle cabin interior side. As a result, it is possible to stably attach the speaker device to the inner panel.

In the speaker device according to a sixth aspect of the present disclosure, in the configuration according to any one of the first to fifth aspects, the inner panel configures a corner portion at a front end side or a rear end side of the vehicle cabin interior, and the outer panel is a fender panel configuring a side face at a front end side or a rear end side of the vehicle.

According to the sixth aspect, the speaker device is disposed at the vehicle inner side of the fender panel. As a result, the speaker device can be disposed at a corner portion at the front end side or the rear end side of the cabin interior, which has relatively little influence on the vehicle cabin interior space.

In the speaker device according to a seventh aspect of the present disclosure, in the configuration according to any one of the first to sixth aspects, the inner panel is a cowl side panel configuring a corner portion at a front end side of the vehicle cabin interior.

According to the seventh aspect, the speaker device is attached to the cowl side panel. Accordingly, the speaker device is disposed at a corner portion at the front end side of the vehicle cabin interior. As a result, it becomes possible to output sound from the front side of a listener (vehicle occupant), the distance between the speaker diaphragm and the listener is shortened, and the required sound pressure level can be lowered.

### Effect of the Invention

As explained above, according to the speaker device according to the present disclosure, the excellent effect of preventing foreign matter from entering and contaminating the port and speaker frame is achieved.

### BRIEF DESCRIPTION OF DRAWINGS

FIG. 1 is a side view of the front portion of a vehicle to which a speaker device according to an embodiment is attached, viewed from outside the vehicle.

FIG. 2 is a perspective view of the front portion of the vehicle to which the speaker device according to an embodiment is attached, viewed from inside the vehicle.

FIG. 3 is a cross-sectional plan view of the front portion of the vehicle and the speaker device in a state sectioned along line 3-3 of FIG. 2.

FIG. 4 is an exploded perspective view of a speaker device according to an embodiment.

FIG. 5 is a front perspective view of a speaker unit configuring a speaker device according to an embodiment.

FIG. 6 is a rear perspective view of a speaker unit configuring a speaker device according to an embodiment.

FIG. 7 is a front perspective view of a port configuring a speaker device according to an embodiment.

FIG. 8 is a rear perspective view of a port configuring a speaker device according to an embodiment.

FIG. 9 is a diagram showing an example of a speaker device according to an embodiment, and showing acoustic characteristics of sound waves generated from a diaphragm.

### BEST MODE FOR CARRYING OUT THE INVENTION

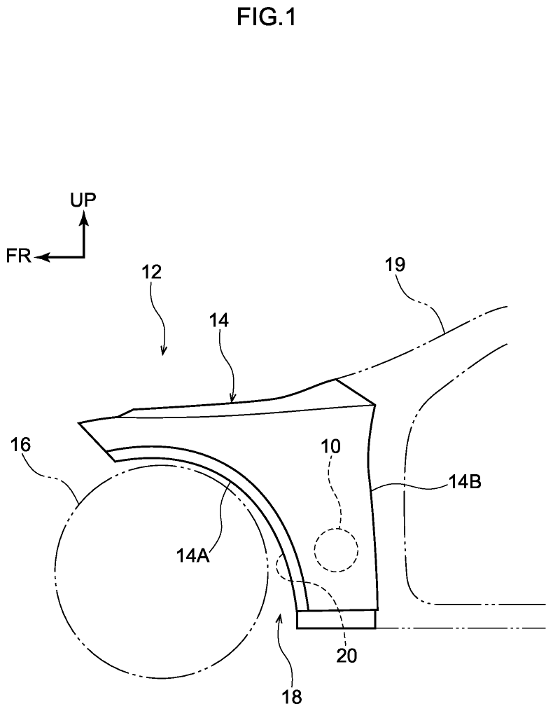

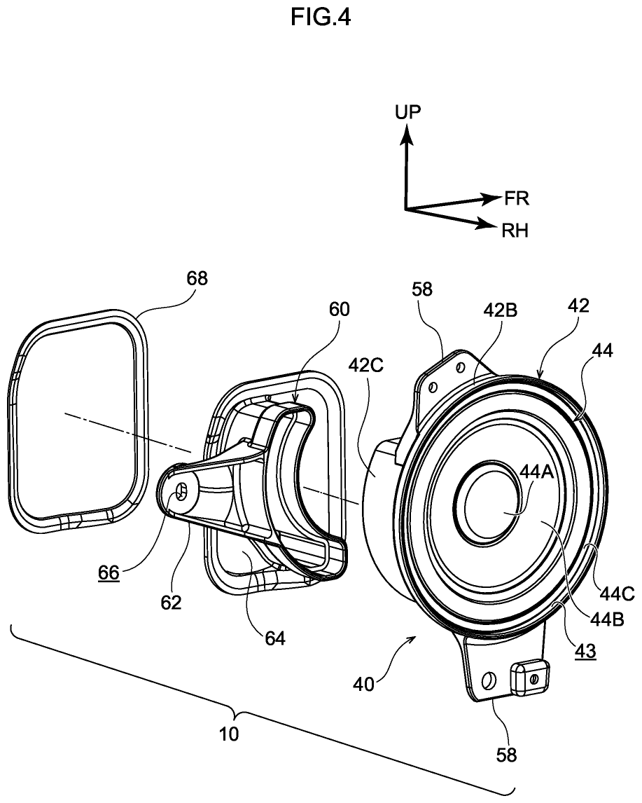

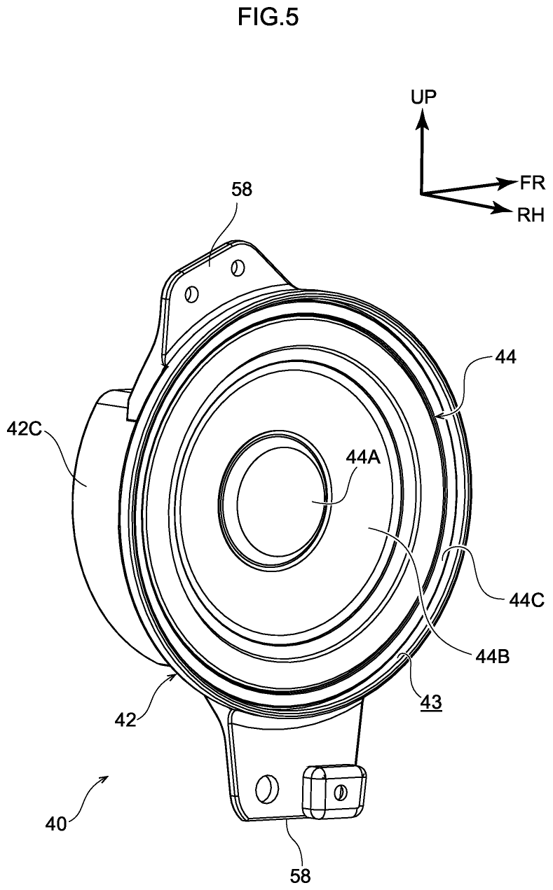

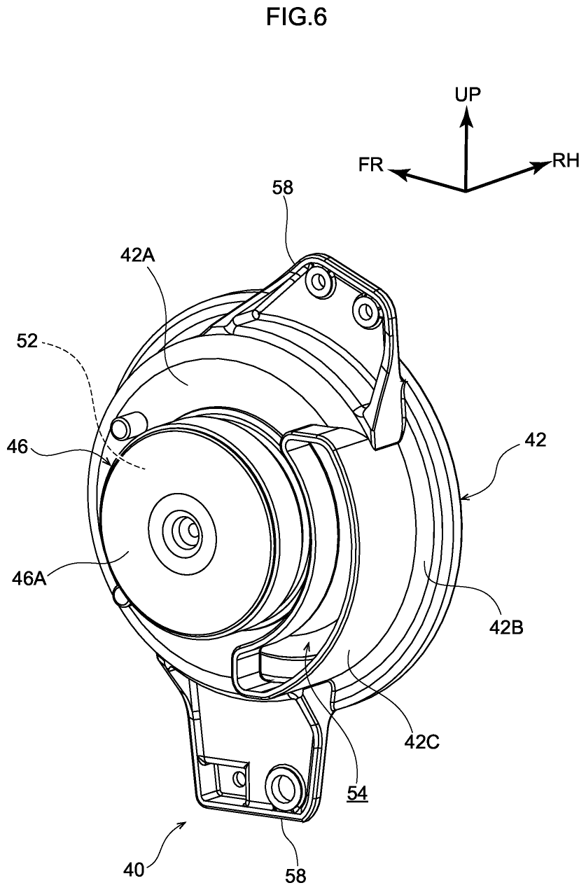

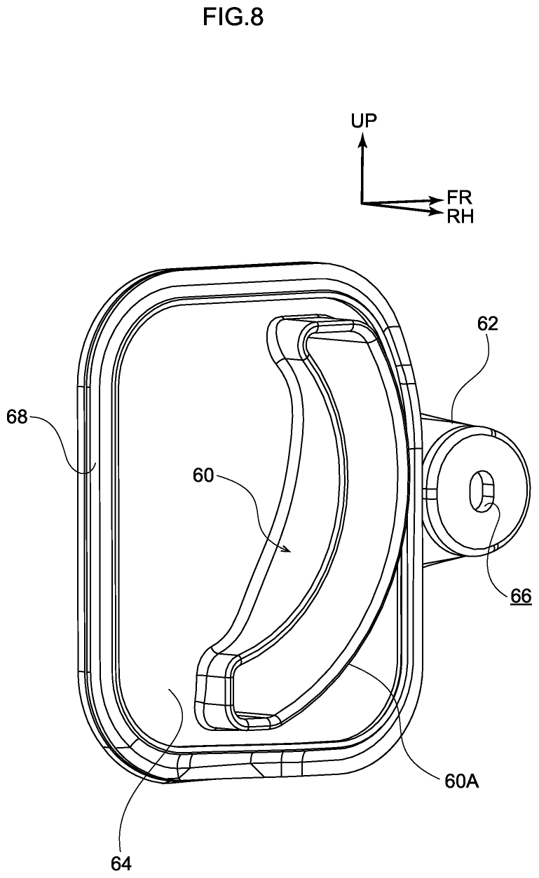

A speaker device 10 according to the present embodiment is described below based on FIGS. 1 to 9. Here, the arrow FR shown as appropriate in the respective drawings indicates the vehicle forward side, the arrow UP indicates the vehicle upper side, and the arrow RH indicates the vehicle right side. In the following explanation, unless specifically stated otherwise, reference to the front and rear, up and down, and left and right directions refers to front and rear in the vehicle front-rear direction, up and down in the vehicle vertical direction, and left and right when facing in the direction of travel.

As shown in FIG. 1, the speaker device 10 according to the present embodiment is applied to the front portion of a vehicle 12. Specifically, the speaker device 10 is attached at a position overlapping with a front fender panel 14 provided at the front portion of the vehicle 12, as viewed in a vehicle width direction. The front fender panel 14 corresponds to an “outer panel” in the present disclosure.

The front fender panel 14 configures an outer panel of the vehicle and is provided as a left and right pair. In addition, in the following explanation, only the front fender panel 14 on the left side of the vehicle will be explained; however, the front fender panel 14 on the right side of the vehicle has a similar configuration.

The front fender panel 14 is disposed at the upper side of a front wheel 16 of the vehicle 12 and is gently curved so as to become outwardly convex in the vehicle width direction. Further, a lower end portion 14A of the front fender panel 14 is formed substantially in the shape of a circular arc around the front wheel. The lower end portion 14A is joined to the upper surface and the outer end portion in the vehicle width direction of a wheel house inner 20 that configures the inner surface of a wheel house 18 in which the front wheel 16 is housed. Further, a rear end portion 14B of the front fender panel 14 is joined, from the outer side, to a front portion and a lower portion of a columnar front pillar 19 extending in the vertical direction.

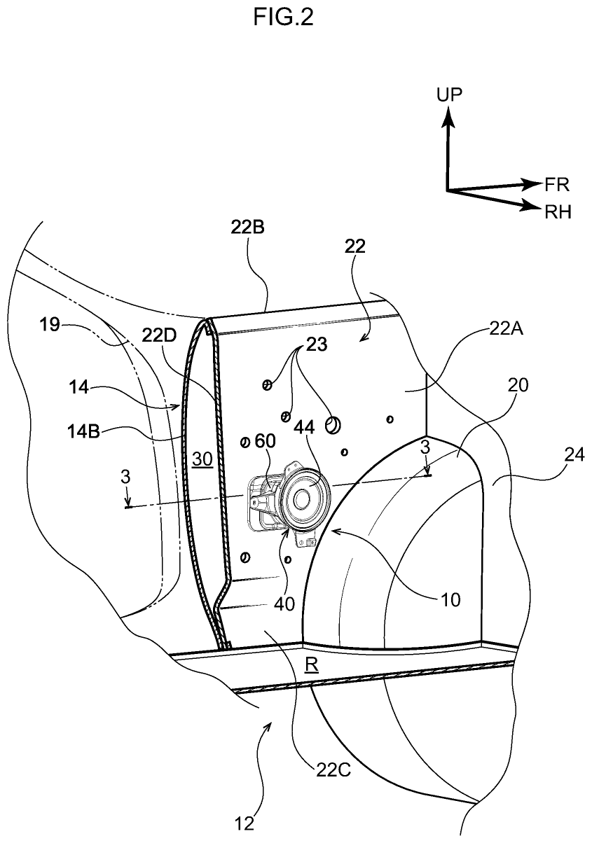

Here, a cowl side panel 22 is arranged inside the front fender panel 14 in the vehicle width direction as an inner panel. As shown in FIG. 2, the cowl side panel 22 has its thickness direction substantially in the vehicle width direction, and extends in the vehicle vertical direction and vehicle front-rear direction. The cowl side panels 22 configures the front portion side of a cabin R of the vehicle 12, and is provided as a left-right pair. A cowl panel extending in the vehicle width direction extends between upper portions of the pair of cowl side panels 22.

The front end portions 22A of the pair of cowl side panels 22 are respectively joined to outer ends in the vehicle width direction of a dash panel 24 that partitions an engine room (not shown) from the vehicle cabin R of the vehicle 12. As a result, the cowl side panel 22 and the dash panel 24 configure a corner portion at the front end side of the vehicle cabin R. A corner portion at the front end side of the vehicle cabin R configures a space behind an instrument panel (not shown) or a space below the instrument panel.

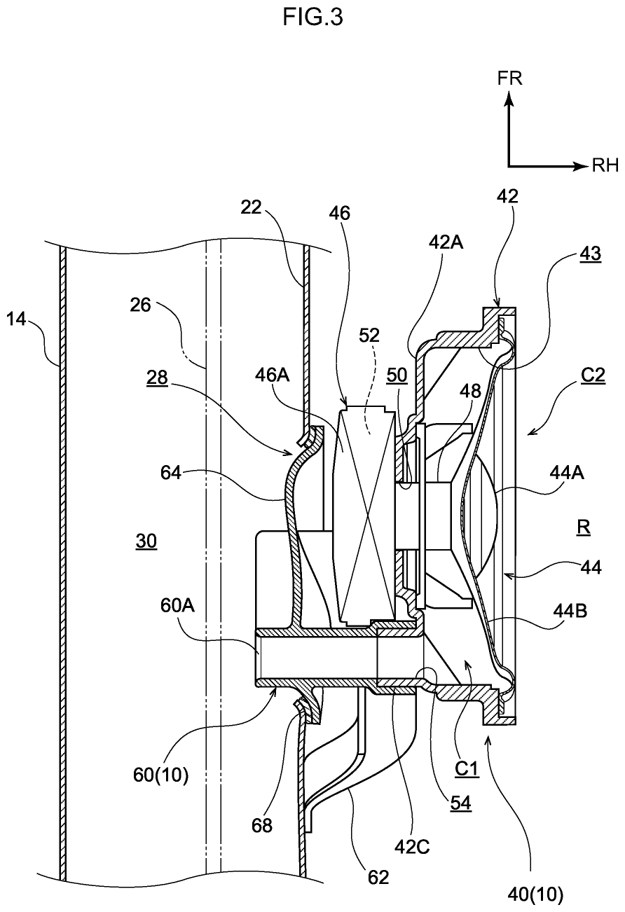

The cowl side panel 22 has a plurality of through holes 23 that penetrate in the thickness direction, and harnesses (not shown) connected to various electrical components can be inserted into these through holes 23. It is desirable that the routing path for such harnesses has a waterproof structure that can withstand disasters such as floods. In the present embodiment, waterproofing is ensured by forming a highly airtight space within a closed cross-section portion 30 formed between the front fender panel 14 and the cowl side panel 22. Specifically, the upper end portion 22B of the cowl side panel 22 is joined to the upper end portion of the front fender panel 14. Further, the lower end portion 22C of the cowl side panel 22 is connected to the upper surface of the wheel house inner 20 and the lower end portion 14A of the front fender panel 14. Furthermore, the rear end portion 22D of the cowl side panel 22 is joined to the front portion and lower portion of the front pillar 19 from the inner side. As a result, the front fender panel 14, the cowl side panel 22, the wheel house inner 20, and the front pillar 19 form a closed cross-section portion 30 that extends in the vehicle vertical direction (see FIGS. 2 and 3).

As shown in FIG. 3, in order to increase the rigidity of the front fender panel 14, a plate-shaped or beam-shaped reinforcing member 26 is interposed between the front fender panel 14 and the cowl side panel 22 inside the closed cross-section portion 30. The reinforcing member 26 is not essential, and the configuration may be such that a plate-shaped waterproof panel is interposed instead of the reinforcing member 26.

The speaker device 10 attached to the cowl side panel 22 is arranged at a front portion of the vehicle cabin R having the configuration described above. The speaker device 10 has a speaker unit 40 including a diaphragm 44 and a port 60 connected to the speaker unit 40.

As shown in FIGS. 3 to 6, the speaker unit 40 has a bottomed cylindrical speaker frame 42, a diaphragm 44 held by the speaker frame 42, and a driver 46 that applies a driving force to the diaphragm 44. A side surface of the speaker frame 42 is configured by a disk-shaped bottom wall 42A and a side wall 42B standing in an axial direction from the outer peripheral portion of the bottom wall 42A. In a state in which the speaker device 10 is attached to the cowl side panel 22, the speaker frame 42 is disposed in an orientation having the vehicle width direction as the axial direction, and opens toward the inside of the vehicle (vehicle cabin R side). The speaker frame 42 is fixed to the cowl side panel 22 via a port 60, which is described below, and in addition, is fixed to an interior panel (not shown) of the vehicle cabin R via an attachment flange 58 projecting in a flange shape from the outer peripheral surface of the side wall 42B. The diaphragm 44 is disposed at one end, in the axial direction, of the speaker frame 42 so as to close an opening 43 of the speaker frame 42.

The diaphragm 44 is, for example, configured with a cone-shaped diaphragm. The diaphragm 44 has a centrally disposed dome-shaped cap portion 44A, a conical cone portion 44B connected to a lower side of the cap portion 44A, and an edge portion 44C formed at the peripheral edge portion of the cone portion 44B. The edge portion 44C of the diaphragm 44 is fixed to the opening 43 of the speaker frame 42 by an adhesive or the like.

In the following explanation, the inner side direction of the vehicle cabin R with respect to the diaphragm 44 is assumed to be the front face side of the diaphragm 44, and the direction toward the outer side of the vehicle with respect to the diaphragm 44 is assumed to be the rear face side of the diaphragm 44.

A first space C1 at the rear face side of the diaphragm 44 is covered by the speaker frame 42 and is thereby partitioned from a second space C2 at the front face side of the diaphragm 44 (i.e., the vehicle cabin R). In the diaphragm 44, one end of a cylindrical voice coil bobbin 48 is connected to the center of the rear face side of the cone portion 44B. The other end of the voice coil bobbin 48 is inserted into an insertion hole 50 passing through the center of the bottom wall 42A of the speaker frame 42, and is inserted into the magnetic gap of a magnetic circuit unit 52 of a driver 46 connected to the rear surface of the speaker frame 42. A voice coil (not shown) is wound around the outer circumference of the voice coil bobbin 48, and the voice coil is disposed in the magnetic gap of the magnetic circuit unit 52. This results in a configuration in which vibration of the voice coil is transmitted to the diaphragm 44 via the voice coil bobbin 48, and the diaphragm 44 vibrates.

The driver 46 has a cylindrical driver case 46A connected to the rear surface of the speaker frame 42, and the magnetic circuit unit 52, which is housed inside the driver case 46A. The magnetic circuit unit 52 includes a magnet and a yoke (not shown), and the electrical signal of reproduced sound flowing through the voice coil causes magnetic repulsion and attraction between the magnetic circuit unit 52 and the voice coil, causing the voice coil to vibrate.

As described above, the speaker frame 42 forms the first space C1 at the rear face side of the diaphragm 44. In a speaker device installed in a vehicle such as the speaker device 10, in conjunction with reductions in installation space, there is a need for miniaturization of the speaker frame 42. In the present embodiment, in order to address the miniaturization of the speaker frame, the spatial volume of the first space C1 on the rear face side of the diaphragm 44 is configured as small as possible, and the objective is to reduce the spatial volume within the speaker frame. As an example, the spatial volume of the first space C1 is set to a minimum of about 2.0 L or less.

Here, when, for example, the first space C1 is configured as a closed space, since, by reducing the spatial volume of the first space C1 as small as possible to about 2.0 L or less, the amplitude of the diaphragm 44 is impeded, it may become impossible to reproduce the desired playback sound. For example, by impeding the amplitude of the diaphragm 44, it becomes difficult to secure the sound pressure in the frequency band necessary for bass playback.

Therefore, in the present embodiment, the configuration is such that the port 60 is connected to the bottom wall 42A that configures the rear face side wall portion (side face) of the speaker frame 42, and the first space C1 at the rear face side of the diaphragm 44 and the inside of the closed cross-section portion 30 are communicated with each other via the port 60. As a result, air can freely flow in and out between the first space C1 at the rear face side of the diaphragm 44 and the inside of the closed cross-section portion 30, and it is possible to prevent a situation in which the vibration of the air in the first space C1 interferes with the amplitude of the diaphragm 44. In addition, in order to facilitate air flow between the first space C1 and the closed cross-section portion 30, it is desirable that the spatial volume of the closed cross-section portion 30 be larger than the spatial volume of the first space C1.

The port 60 is connected to the speaker frame 42 via a port connection portion 42C provided at the bottom wall 42A of the speaker frame 42. The port connection portion 42C is a cylindrical portion protruding from the edge of a port opening 54 penetrating the bottom wall 42A of the speaker frame 42 toward the rear face side. The port opening 54 is formed at a radial direction outer side of the insertion hole 50 formed in the center of the bottom wall 42A, and is an elongated hole extending in an arc shape along the circumferential direction of the speaker frame 42. The port connection portion 42C and the port 60 are also cylindrical members curved in an arc corresponding to the port opening 54. The speaker frame 42 can be connected to the port 60 by inserting the port connection portion 42C into one end of the port 60. In addition, in a state in which the port is connected to the speaker frame 42, since the port 60 is disposed curved along the circumferential direction of the speaker frame 42, the port 60 is positioned radially outward of, and spaced apart from, the driver 46.

As shown in FIGS. 3, 7 and 8, the port 60 extends along the axial direction from the rear face side of the speaker frame 42. In a state in which the port 60 is attached to the cowl side panel 22, the leading end side of the port 60 is inserted into a vehicle-side opening 28 penetrating the cowl side panel 22, and is disposed inside the closed cross-section portion 30. Inside the closed cross-section portion 30, the leading end portion 60A of the port 60 is disposed closer to the vehicle inner side than the reinforcing member 26.

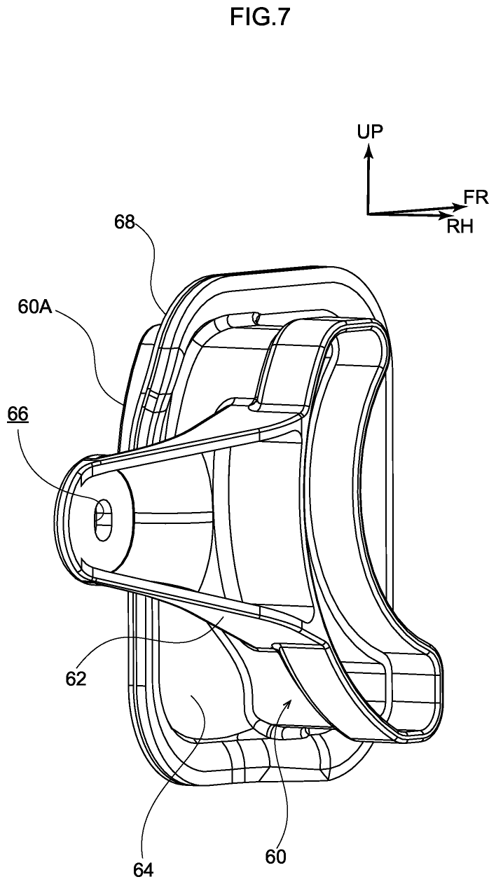

The port 60 is attached to the cowl side panel 22 via an attachment leg portion 62 and an attachment collar portion 64 that are integrally formed on the outer peripheral surface of the port 60. At the port 60, the attachment leg portion 62 extends from an end portion at a side of connection with the speaker frame 42, and sets down on the side surface of the cowl side panel 22 on the inside of the vehicle cabin R. In the attachment leg portion 62, an attachment hole 66 (see FIG. 7) that penetrates the attachment leg portion 62 is formed at the leading end side that is set down on the cowl side panel 22. The attachment leg portion 62 is fixed to the cowl side panel 22 by a bolt (not shown) inserted into the attachment hole 66.

The attachment collar portion 64 is provided at an intermediate portion in the extension direction (axial direction) of the port 60 and protrudes from the outer peripheral surface of the port 60 in a collar shape. The attachment collar portion 64 is formed in a rectangular shape when viewed from the axial direction of the port 60, and closes off the vehicle-side opening 28 formed in the cowl side panel 22 from the inside of the vehicle cabin R. A rectangular frame-shaped seal member 68 made of an elastic material is interposed between the attachment collar portion 64 and the cowl side panel 22, and in addition to vibration during travel being absorbed by the seal member 68, airtightness between the port 60 and the vehicle-side opening 28 is improved.

In this way, the space at the rear face side of the diaphragm 44 (first space C1) and the inside of the closed cross-section portion 30 of the vehicle 12 are communicated with each other by the port 60 connected to the bottom wall 42A of the speaker frame 42. As a result, air at the rear face side of the diaphragm 44 can freely flow in and out between the space at the rear face side of the diaphragm 44 and the inside of the closed cross-section portion 30 of the vehicle 12, and this makes it possible to avoid a situation in which vibration of the diaphragm 44 is impaired by the air pressure in the first space C1.

Here, in the present embodiment, the port 60 connected to the speaker frame 42 has a predetermined cross-sectional area (opening area) and length, whereby it configures a Helmholtz resonator together with the speaker frame 42.

In addition, in order to make the air inside the port 60 resonate by Helmholtz resonance, the opening area of the port 60 at least needs to be configured smaller than the area of the side surface of the speaker frame 42 to which the port 60 is connected. That is, by configuring the opening area of the port 60 to be smaller than the area of the side surface of the speaker frame 42 to which the port 60 is connected, a closed space can be formed within the speaker frame 42, and the air in the closed space acts as an air spring and resonates with the air inside the port 60 with which it is communicated. For example, by communicating the air in a very small closed space of 2.0 L or less with the air flow in the port, it becomes possible to adjust characteristics using the air load mass of the port.

Thus, the speaker device 10 configured as described above is a system in which a Helmholtz resonator is configured by a speaker frame 42 having a closed space and a port 60.

In the present embodiment, the configuration is such that the leading end side of the port 60 is disposed in the closed cross-section portion 30, and the reproduced sound of the speaker device 10 is designed based on the acoustic characteristics of the sound waves generated by the diaphragm 44. In addition, by adjusting the sealing properties within the closed cross-section portion 30 to which the port 60 is connected, the configuration is designed such that the sound pressure of the sound reproduced by the speaker device 10 can be intentionally adjusted to a desired frequency band.

Furthermore, by adjusting the length and opening area of the port 60 and thereby changing the resonance point (resonance frequency) of the port 60 and adjusting the resonance point of the air within the port and speaker frame, the acoustic frequency characteristics of the diaphragm 44 in a predetermined band are adjusted. In the example described below, the acoustic frequency characteristics of the diaphragm 44 are determined by the area S1 of the diaphragm 44, the opening area S2 of the port 60, and the length L1 of the port 60.

### EXAMPLE

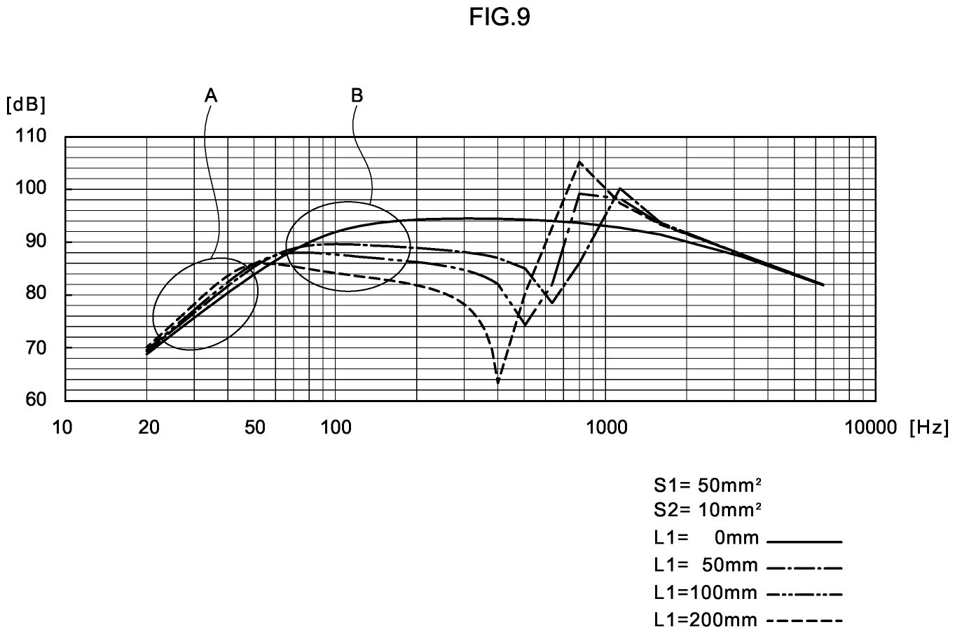

FIG. 9 is an acoustic characteristic graph in which the vertical axis represents sound pressure [dB] and the horizontal axis represents frequency [Hz]. This figure shows the acoustic characteristics of sound waves generated from the diaphragm of the speaker device according to the example toward the interior cabin of the vehicle. The speaker device according to the example has the configuration of the speaker device 10 according to the above-described embodiment, and the area S1 of the diaphragm 44 is set to S1=200 mm², and the opening area S2 of the port 60 is set to S2=40 mm². In FIG. 9, in the speaker device having the above-described configuration, the acoustic characteristics when the port length L1 is set to (0 mm/50 mm/100 mm/200 mm) are shown, and the port length L1=0 mm is indicated by a solid line, L1=50 mm is shown by a one-dot chain line, L1=100 mm is indicated by a two-dot chain line, and L1=200 mm is shown by a broken line.

As shown in FIG. 9, even if the speaker device has a port length L1=0 mm, the acoustic characteristics of the diaphragm alone can be maintained.

According to area A shown in FIG. 9, by changing the port length L1 to 50 mm, 100 mm, and 200 mm, compared with the sound pressure value according to the acoustic characteristics when L1=0 mm, it can be seen that the sound pressure in the frequency band of the bass range of approximately 20 Hz to 50 Hz is enhanced.

Furthermore, according to region B shown in FIG. 9, by changing the port length L1 to 50 mm, 100 mm, and 200 mm, compared with the sound pressure value according to the acoustic characteristics when L1=0 mm, it can be seen that the sound pressure in the mid-range frequency band of approximately 100 Hz to 400 Hz is attenuated as the length of the port becomes longer.

Therefore, according to the above-described embodiment, in order to secure the sound pressure in the mid-range frequency band while increasing the sound pressure in the bass range frequency band, for example, it can be seen that it is preferable to configure the port L1 in the range of 50 mm to 100 mm.

### (Mechanism and Effects)

As explained above, in the speaker device according to the present embodiment, the first space C1 at the rear face side of the diaphragm 44 and the inside of the closed cross-section portion 30 are communicated with each other via the port 60 extending from the bottom wall 42A (side surface) of the speaker frame 42. Therefore, since the opening at the leading end side of the port 60 is disposed toward the inside of the closed cross-section portion 30, foreign matter such as snow, rainwater, dust, and insects from outside the vehicle can be prevented from entering the speaker frame 42 through the opening of the port 60. Accordingly, the flow of air within the port 60 and the speaker frame 42 is not obstructed by foreign matter, and favorable reproduction performance of the speaker device 10 can be maintained.

Further, air can enter and exit between the first space C1 of the diaphragm 44 and the inside of the closed cross-section portion 30 via the port 60. Accordingly, compared to a case of forming the space inside the speaker frame as a sealed space, interference by the air pressure within the speaker frame 42 with the amplitude of the diaphragm 44 is suppressed. As a result, since it becomes possible to release pressure from inside the speaker frame 42 to the closed cross-section portion 30 of the cowl side panel 22 and the front fender panel 14 through the port 60 while maintaining the amplitude of the diaphragm 44, the device can be made smaller while maintaining the reproduction performance of the speaker device 10.

Further, the speaker frame 42 is attached to the cowl side panel 22 that configures the frame of the vehicle. Accordingly, the installation of the speaker frame 42 is stabilized, and it is possible to suppress abnormal noise and rattling from occurring at the mounting surface of the speaker frame caused by vibration or the like while the vehicle 12 is running.

Further, in the present embodiment, by configuring the opening area of the port 60 to be smaller than the area of the bottom wall 42A of the speaker frame 42 to which the port 60 is connected, air in the port 60 resonates using the air in the first space C1 at the rear face side of the diaphragm 44 as an air spring.

The resonance point (resonance frequency) of the port 60 is changed depending on the length of the port 60. Therefore, it is possible to change the resonance point of the port 60 by adjusting the length of the port 60 and to intentionally adjust the sound pressure of sound reproduced by the speaker device 10 in a predetermined frequency band.

In the present embodiment, since it is possible to dispose the leading end side of the port 60 within the closed cross-section portion 30, in terms of securing installation space, fewer restrictions are caused by the structure of the vehicle, and the length of the port 60 can be easily adjusted. As a result, sound reproduced by the speaker device 10 can be adjusted with a simple structure.

Furthermore, since the leading end of the port 60 is disposed within the closed cross-section portion 30, by adjusting the length of the port 60 in accordance with variations in the sealing performance within the closed cross-section portion 30, it is possible to intentionally adjust the sound pressure of sound reproduced by the speaker device 10 in a predetermined frequency band.

Further, in the present embodiment, the leading end portion 60A of the port 60 is disposed at an inner side of the vehicle with respect to the reinforcing member 26 (or waterproof panel) interposed between the cowl side panel 22 and the front fender panel 14. Accordingly, since the port 60 can be attached at a position that does not interfere with the reinforcement and waterproof structure within the closed cross-section portion 30, the speaker device can be easily attached to the frame of the vehicle 12.

Further, in the present embodiment, at the cowl side panel 22, a through hole 23 is formed through which a harness connected to an electrical component is inserted. In this way, locations at which electrical components of a vehicle are installed are generally designed to be waterproof in readiness for a case in which the vehicle is submerged in water. Accordingly, even if a vehicle-side opening 28 through which the port 60 is inserted is formed in the cowl side panel 22, the waterproof performance within the closed cross-section portion 30 can be ensured. Since, as a result, the need for waterproof design at the speaker device 10 side is eliminated, the degree of freedom of design of the speaker device 10 can be increased.

Further, in the present embodiment, the attachment leg portion 62 provided integrally with the port 60 extends from the end of the port 60 at the side of connection with the speaker frame 42 to the side face of the cowl side panel 22 at the inside of the cabin R of the vehicle 12. Accordingly, since the attachment leg portion 62 of the port 60 extends from near the center of gravity of the speaker device 10, the attachment of the speaker device 10 can be stabilized.

Further, in the present embodiment, the speaker device is attached to the cowl side panel 22 and is disposed at the vehicle inner side of the front fender panel 14. As a result, the speaker device 10 can be disposed at a corner portion at the front end side of the vehicle cabin R, where its influence on the vehicle cabin R space of the vehicle 12 is relatively small.

Furthermore, it becomes possible to output sound from the front side of the listener (vehicle occupant), the distance between the speaker diaphragm and the listener is shortened, and the required sound pressure level can be lowered.

### [Supplementary Explanation]

In each of the embodiments described above, an inner panel and an outer panel according to the present invention are configured by a cowl side panel and a front fender panel; however, the present disclosure is not limited to this. For example, the inner panel and outer panel forming the closed cross-section portion may be configured by the inner panel and outer panel of a pillar that configures a frame member of the vehicle.

Alternatively, the rear fender panel of the vehicle may be configured as the outer panel of the present invention, and a frame member of the vehicle disposed at the inner side of the rear fender panel may be configured as the inner panel.

Furthermore, in the above-described embodiment, the speaker frame 42 is configured connectably to the port 60 by inserting the port connection portion 42C into one end of the port 60; however, there is no limitation to this. The port connection portion 42C and the port 60 may be formed integrally.

The disclosure of Japanese Patent Application No. 2021-077573 filed on Apr. 30, 2021, is incorporated herein by reference in its entirety.

All publications, patent applications and technical standards mentioned herein are incorporated herein by reference to the same extent as if each individual publication, patent application and technical standard were specifically and individually indicated to be incorporated by reference.

1. A speaker device, provided at a vehicle cabin interior at which a closed cross-section portion is formed by an inner panel and an outer panel, the speaker device comprising:
a speaker frame that is fixed to the inner panel and that partitions a space at a rear face side of a diaphragm relative to a space at a front face side of the diaphragm; and
a port extending from a side face of the speaker frame,
wherein the port communicates the space at the rear face side of the diaphragm and an interior of the closed cross-section portion with each other.

2. The speaker device of claim 1, wherein an opening area of the port is configured smaller than an area of the side face of the speaker frame to which the port is connected.

3. The speaker device of claim 1, wherein a leading end of the port is disposed at a vehicle inner side relative to a reinforcing member or a waterproof panel disposed between the inner panel and the outer panel in the closed cross-section portion.

4. The speaker device of claim 1, wherein a through hole, through which is inserted a harness connected to electrical equipment installed in the vehicle, is formed at the inner panel.

5. The speaker device of claim 1 to 4, wherein:
an attachment leg portion that is attached to the inner panel is integrally formed at the port, and
the attachment leg portion extends from an end portion of the port at a side of connection with the speaker frame and sets down on a side face at a vehicle cabin interior side of the inner panel.

6. The speaker device of claim 1, wherein:
the inner panel configures a corner portion at a front end side or a rear end side of the vehicle cabin interior, and
the outer panel comprises a fender panel configuring a side face at a front end side or a rear end side of the vehicle.

7. The speaker device of claim 1, wherein the inner panel comprises a cowl side panel configuring a corner portion at a front end side of the vehicle cabin interior.
